(19) United States
(12) Patent Application Publication
(10) Pub. No.: US 2006/0227823 A1
(43) Pub. Date: Oct. 12, 2006

(54) Electroabsorption vertical cavity surface emitting laser modulator and/or detector

(76) Inventors: Edris Mohammed, Hillsboro, OR (US); Ian Young, Portland, OR (US); Serge Oktyabrsky, Wynantskill, NY (US); Michael Yakimov, Albany, NY (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/094,873

(22) Filed: Mar. 30, 2005

(51) Int. Cl. H01S 3/10

(52) U.S. Cl. 372/26

(57) ABSTRACT

An electroabsorption vertical cavity surface emitting laser modulator and/or detector includes a lower reflector, an upper reflector, a middle reflector, a gain region, and an absorber region integrated into a semiconductor die. The middle reflector is disposed between the lower and upper reflectors. Together, the lower and middle reflectors define a first resonant cavity within the semiconductor die, while the upper and middle reflectors define a second resonant cavity within the semiconductor die. The first and second resonant cavities are optically coupled. The gain region is disposed within the first resonant cavity and is capable of generating an optical carrier wave. The absorber region is disposed within the second resonant cavity and is capable of modulating a signal on the optical carrier wave when subjected to a signal voltage.

### TECHNICAL FIELD

This disclosure relates generally to electro-optic devices, and in particular but not exclusively, relates to a monolithically integrated surface emitting laser with dual resonant cavities.

### BACKGROUND INFORMATION

Semiconductor lasers have a variety of applications including communication systems and consumer electronics. Generally, semiconductor lasers may be categorized as edge-emitting lasers or surface emitting lasers (“SELs”). An edge-emitting laser emits radiation parallel to a surface of the semiconductor wafer or die, while a SEL emits radiation substantially perpendicular to the surface. One common type of SEL is a vertical cavity SEL (“VCSEL”). A VCSEL includes a gain region within a resonant cavity having a surface aperture to emit light from the resonant cavity.

There are two main techniques for modulating a signal onto an optical carrier wave emitted from a semiconductor laser—direct modulation and external optical modulation. Direct modulation encodes the optical carrier wave with a signal by directly modulating the drive current applied to the gain region of the semiconductor laser. The bandwidths achieved by direct modulation are limited due to the finite relaxation oscillation time of an excited state electron within the gain region. This finite relaxation oscillation time can result in inter-symbol interference (“ISI”) between adjacent clock cycles. With external optical modulation, the semiconductor laser emits a continuous wave (“CW”) carrier, which is externally modulated by an external optical modulator (“EOM”). EOMs are typically distinct entities from the CW carrier source and therefore more expensive to manufacture than directly modulated lasers, but are capable of achieving higher modulation bandwidths.

Generally, EOMs may be categorized as electro-refraction modulators and electro-absorption modulators. Electro-refraction modulators rely on changes in the index of refraction of a material induced by an applied electric field to modulate the proportion of light through the modulator (for example Mach-Zehnder interferometer). Electro-absorption modulators achieve the desired light modulation by modifying the light absorbing properties of a material with an electric field.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 is a cross-sectional perspective of an electroabsorption vertical cavity surface emitting laser modulator and/or detector, in accordance with an embodiment of the invention.

FIG. 2 is a top view perspective of an electroabsorption vertical cavity surface emitting laser modulator and/or detector, in accordance with an embodiment of the invention.

FIG. 3 illustrates cross-sectional and top view perspectives of a planar array of quantum dots, in accordance with an embodiment of the invention.

FIG. 4 is a cross-sectional perspective illustrating a multiple quantum well structure, in accordance with an embodiment of the invention.

FIG. 5 is a diagram illustrating physical position of an absorber region and/or gain region within a resonant cavity, in accordance with an embodiment of the invention.

FIG. 6 is a flow chart illustrating a process for operation of an electroabsorption vertical cavity surface emitting laser modulator and/or detector in an optical source regime, in accordance with an embodiment of the invention.

FIG. 7 is a flow chart illustrating a process for operating an electroabsorption vertical cavity surface emitting laser modulator and/or detector in an optical detector regime, in accordance with an embodiment of the invention.

FIG. 8 is a functional block diagram illustrating a demonstrative system implemented with electroabsorption vertical cavity surface emitting laser modulators and/or detectors, in accordance with an embodiment of the invention.

### DETAILED DESCRIPTION

Embodiments of an Electroabsorption VCSEL (vertical cavity surface emitting laser) Modulator (“EAVM”) and/or detector including dual resonant cavities are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

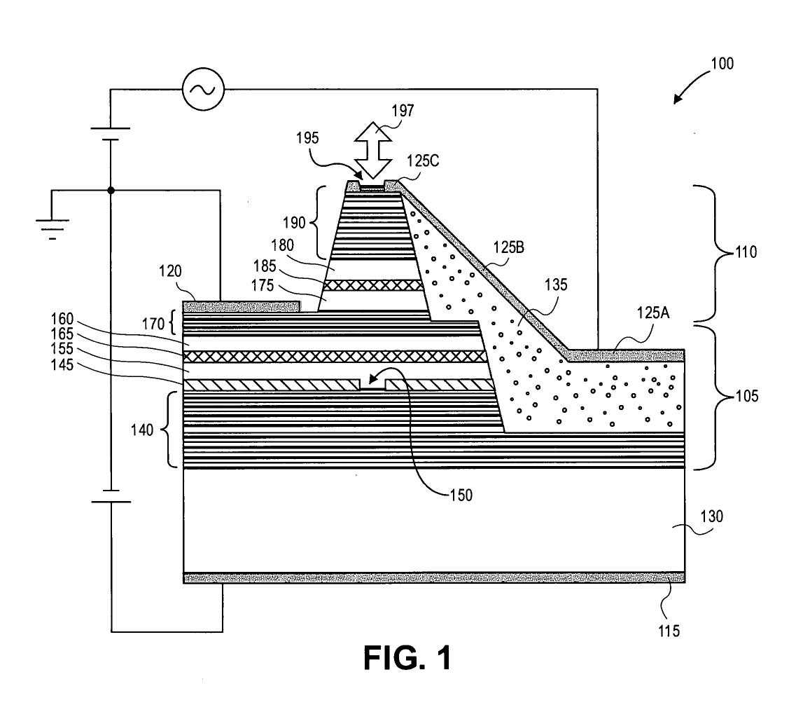

FIG. 1 is a cross-sectional perspective of an EAVM 100, in accordance with an embodiment of the invention. Embodiments of EAVM 100 may be configured to operate as either an optical source or an optical detector, as is described below. The word “detector” has been excluded from the acronym “EAVM” for convenience sake and it should not be implied that EAVM 100 is not capable of operating in a optical detector regime.

The illustrated embodiment of EAVM 100 includes a lower resonant cavity 105 (gain section) and an upper resonant cavity 110 (modulator section), a drive electrode 115, a ground electrode 120, signal electrodes 125A, B, C (collectively 125), a substrate layer 130, and a dielectric material 135. The illustrated embodiment of lower resonant cavity 105 includes a lower reflector 140, an oxide layer 145 having a confinement aperture 150 therein, barrier layers 155 and 160, a gain region 165 and a middle reflector 170. The illustrated embodiment of upper resonant cavity 110 includes middle reflector 170, barrier layers 175 and 180, an absorber region 185, upper reflector 190, and a surface aperture 195.

In one embodiment, during a optical source regime of EAVM 100, lower and upper resonant cavities 105 and 110 of EAVM 100 are weakly coupled micro-cavities, which together provide the functionality of an optical source and external optical modulator, respectively, but integrated into a single semiconductor die. Additionally, during an optical detecting regime of EAVM 100, gain region 165 may be disabled via appropriate biasing and absorber region 185 operated to detect an optical signal impinging upon surface aperture 195.

In one embodiment, substrate layer 130 is one layer of a semiconductor die, such as a gallium arsenide (GaAs) based semiconductor die, a silicon based semiconductor die, various other type III-V semiconductor materials, type IV semiconductor materials, or the like. In one embodiment, substrate layer 130 is a n-type doped GaAs substrate.

In the illustrated embodiment, lower, middle, and upper reflectors 140, 170, and 190 are distributed Bragg reflectors (“DBRs”) including alternating layers of GaAs and AlGaAs. In one embodiment, lower reflector 140 is fully reflective at the carrier wavelength of emitted optical signal 197, while middle and upper reflectors 170 and 190 are at least partially reflective to encourage lasing and partially transmissive to emit optical signal 197. The attributes of lower resonant cavity 105 may be selected for coarse resonance tuning of a carrier wavelength generated by gain region 165, while the attributes of upper resonant cavity 110 may be selected for fine resonance tuning of the carrier wavelength and to provide for adequate weak coupling between upper and lower resonant cavities 105 and 110. The thickness of each alternating layer within the reflector may be chosen to select a desired center resonance frequency and therefore nominal carrier wavelength of optical signal 197 emitted from EAVM 100. In one embodiment, where the carrier wavelength is selected to fall between 850 nm and 900 nm, the alternating layers of lower and middle reflectors 140 and 170 may have quarter, half, or full wavelength thickness to place the Bragg wavelength of lower and middle reflectors 140 and 170 at the desired carrier wavelength.

In one embodiment, lower, middle, and upper reflectors 140, 170, and 190 are doped to establish p-n junctions within upper and lower resonant cavities 105 and 110. For example, lower and upper reflectors 140 and 190 may be doped to have an n-type conductivity while middle reflector 170 may be doped to have a p-type conductivity, thereby creating an n-p-n structure. Of course, lower, middle, and upper reflectors 140, 170, and 190 may also be doped to create a p-n-p structure with a corresponding polarity change in the bias voltages/signals applied to electrodes 115, 125, and 130 (discussed below).

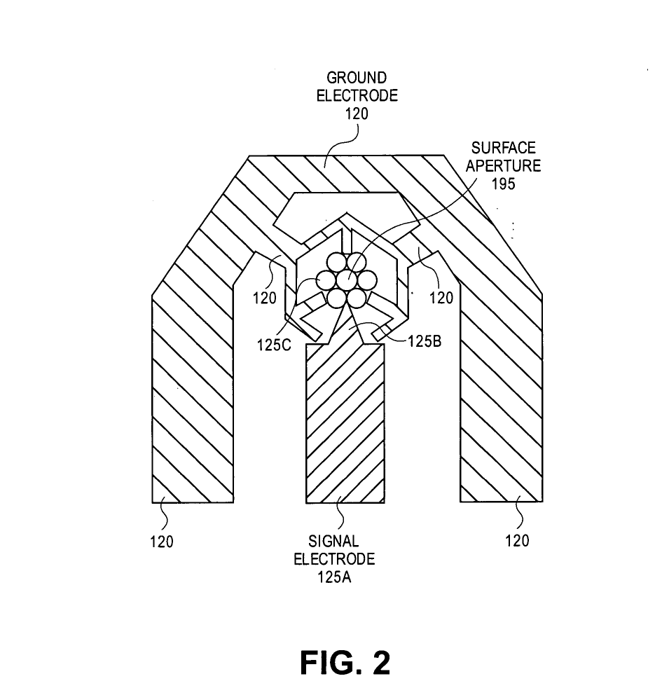

FIG. 2 is a top view perspective of a EAVM 100, in accordance with an embodiment of the invention. Electrodes 115 (not illustrated in FIG. 2), 120, and 125 may be fabricated of a variety of electrically conductive materials. In one embodiment, drive electrode 115 and signal electrode 125 are made of NiAuGe to form an electrical contact with n-doped substrate layer 130 and n-doped upper reflector 190, while ground electrode 120 is made of PdTiAu to form an electrical contact with p-doped middle reflector 170. In one embodiment, a metallization layer is formed with CrAu. Other conductive materials may also be used.

Returning to FIG. 1, during the optical source regime of operation, a direct current (“DC”) voltage may be applied between drive electrode 115 and ground electrode 120 to forward bias gain region 165 and supply a DC drive current thereto for generating the carrier wave. A second DC bias voltage may also be applied between signal electrode 125 and ground electrode 120 to reverse or neutrally bias absorber region 185. In addition, an alternating current (“AC”) signal voltage may be superimposed onto the second DC voltage to modulate the optical absorption properties of absorber region 185, thereby modulating the optical carrier wave with the signal voltage and generating optical signal 197. In one embodiment, the modulation of the optical carrier wave is an amplitude modulation. During the optical detecting regime of operation, drive electrode 115 may be biased to turn off gain region 165, while signal electrode 125 is biased to maintain absorber region 185 in a reverse biased state.

Oxide layer 145 provides an electrical and optical barrier layer. Confinement aperture 150 defined in oxide layer 145 provides a sort of beam shaping function using both current and optical confinement. Oxide layer 145 has a lower index of refraction than confinement aperture 150 and therefore the optical intensity of the optical carrier wave is laterally confined to establish the optical mode along the center of EAVM 100 through confinement aperture 150 and beneath surface aperture 195. Furthermore, oxide layer 145 is an electrical insulator that restricts the DC drive current between drive electrode 115 and ground electrode 120 to flow through confinement aperture 150. By restricting the DC drive current to flow through confinement aperture 150, the stimulated emission is laterally concentrated (high carrier densities) in gain region 165 above confinement aperture 150 and below surface aperture 195. In one embodiment, oxide layer 145 is formed of Al(Ga) oxide and a wet selective oxidation technique is used to form confinement aperture 150. It should be appreciated that other electrical and optical barrier materials and fabrication techniques may be substituted. For example, another oxide layer with a confinement aperture may be placed above gain region 165, or two or more oxide layers with confinement apertures may be used above and/or below gain region 165 to increase the optical field or/and current confinements. In one embodiment, confinement aperture 150 is approximately 6 μm in diameter.

Barrier layers 155 and 160 surround gain region 165 and act to increase injection efficiency into gain region 165 from the surrounding material layers. In one embodiment, barrier layers 155 and 160 are formed of AlGaAs, while gain region 165 is a superlattice formed of InGaAs, GaAs, or other optically active materials. Similarly, other material constituents may be used to form barrier layers 155 and 160. In one embodiment, barrier layers 155 and 160 are approximately 50 nm thick. In one embodiment, the thickness of barrier layers 155 and 160 and gain region 165 are such that lower resonant cavity 105 is a half-wavelength cavity. The thicknesses of barrier layers 155 and 160 may be adjusted to adjust the resonant frequency of lower resonant cavity 105.

Gain region 165 acts as a gain medium to emit the optical carrier wave. Gain region 165 is driven by the DC current to create a charge carrier population inversion within gain region 165 and thereby establish conditions favorable for stimulated emission. The DC drive current is generated by applying an appropriate bias current between drive electrode 115 and ground electrode 120. In one embodiment, stimulated emission is created by forward biasing gain region 165 with drive electrode 115 and ground electrode 120.

Gain region 165 may be formed of a variety of optically active materials, including for example layers of InGaAs or GaAs with AlGaAs barriers. Gain region 165 may be constructed as a multi-layer quantum dot (“MQD”) structure or a multi-layer quantum well (“MQW”) structure. An MQD structure provides three dimensional carrier confinement, while the MQW structure provides one dimensional carrier confinement.

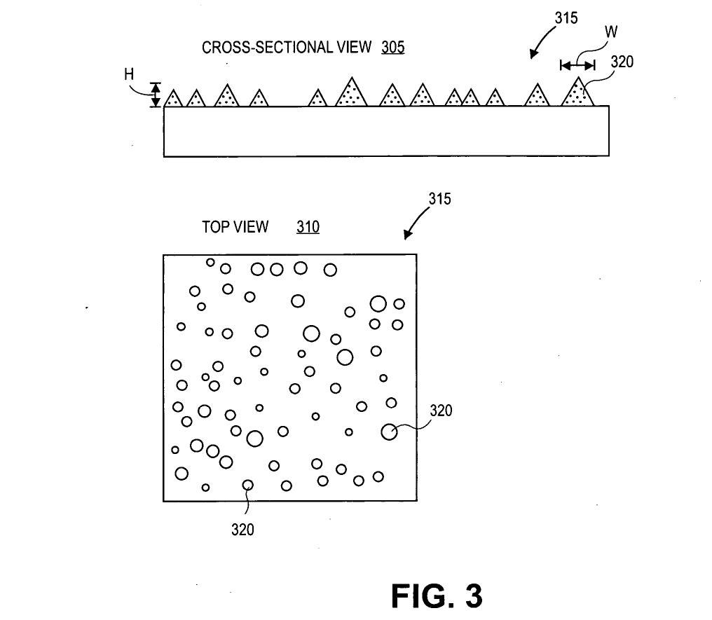

FIG. 3 illustrates a cross-sectional view 305 and a top view 310 including a planar array 315 of quantum dots 320, in accordance with an embodiment of the invention. In the illustrated embodiment, quantum dots 320 are pyramid-like quantum structures formed in a substantially planar array 315, though other three dimensional shapes may be implemented. Quantum dots 320 may fabricated of one material and surround by a second mortar material. In one embodiment, quantum dots 320 are formed with InGaAs, while the surrounding mortar material is AlGaAs. In one embodiment, quantum dots are 3 nm to 5 nm in height H and approximately 20 nm to 30 nm in diameter or width W. Quantum dots 320 may be evenly distributed or randomly distributed. To form a MQD structure several layers of planar array 315 may be stacked on top of each other (for example 2-10 layers). Accordingly, cross-sectional view 305 and top view 310 illustrated only one layer of a MQD structure.

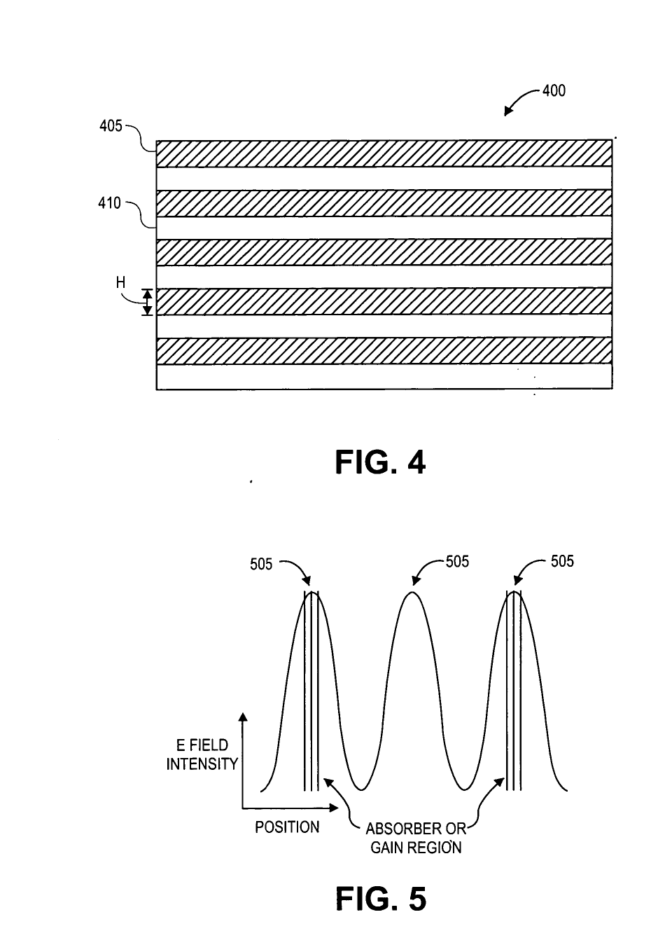

FIG. 4 is a cross-sectional perspective illustrating a MQW structure 400, in accordance with an embodiment of the invention. MQW structure 400 may be formed of the same materials and with similar dimensions as the MQD structure of FIG. 3. In one embodiment, MQW structure 400 includes an alternating stack of five InGaAs layers 405 and five AlGaAs layers 410 in a second mixing proportion. Other materials and number of layers may also be used.

The MQD structure of FIG. 3 or the MQW structure of FIG. 4 may be used to implement absorber region 185, as well as, gain region 165. These structures act to confine charge carriers at positions within lower resonant cavity 105 and upper resonant cavity 110 where the electric field intensity is highest, as illustrated in FIG. 5. By positioning gain region 165 and absorber region 185 at E-field intensity peaks 505 within lower and upper resonant cavities 105 and 110, the quantum efficiency of these structures is improved and the modulation contrast/gain efficiency increased.

Returning to FIG. 1, absorber region 185 may be formed of a variety of optically active materials, including for example a superlattice of InGaAs and GaAs. As discussed above, this superlattice may be constructed using a MQD structure or a MQW structure. Barrier layers 175 and 180 surround absorber region 185 and act to buffer absorber region 185 from the surrounding material layers and form half-wavelength thick or quarter-wavelength thick structures with absorber region 185. In one embodiment, barrier layers 175 and 180 are formed of InGaAs or other material constituents including AlGaAs. In one embodiment, barrier layers 175 and 180 are approximately 100 nm thick and form a PIN structure with absorber region 185. The dimensions of upper and lower resonant cavities 105 and 110 along with the thickness of middle reflector 170 determine resonant modes within EAVM 100 and the amount of coupling between upper and lower resonant cavities 105 and 110.

Surface aperture 195 may be patterned in a variety of shapes, including a circle, as illustrated in FIG. 2, to provide uniform vertical current flow and to reduce the effect on optical signal 197 and to further beam shape optical signal 197. In one embodiment, surface aperture 195 has a diameter of approximately 15 μm, while EAVM 100 has an approximate overall height of 10 μm from the bottom of lower reflector 140 to the top of surface aperture 195.

Finally, dielectric material 135 may be formed between the inner components of EAVM 100 and signal electrode 125 for planarization, mechanical protection, and electric isolation. In one embodiment, dielectric material 135 is a reflowable polymer material.

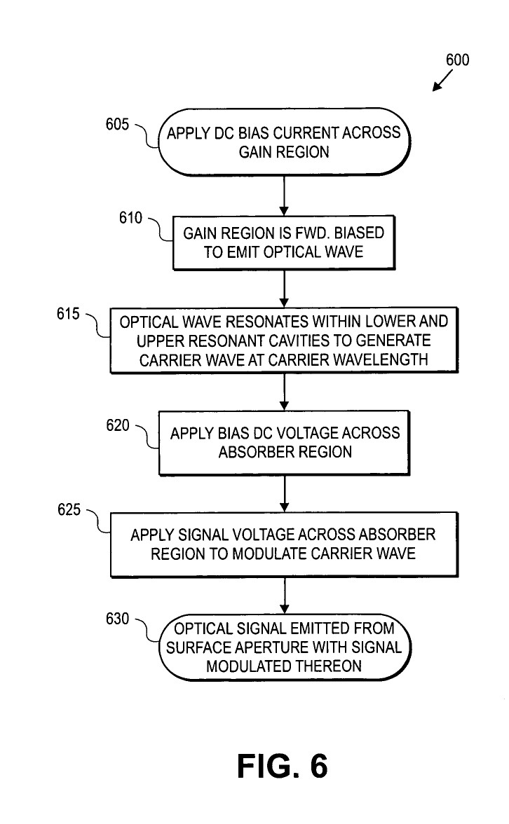

FIG. 6 is a flow chart illustrating a process 600 for operation of EAVM 100 in the optical source regime, in accordance with an embodiment of the invention. The order in which some or all of the process blocks appear in each process below should not be deemed limiting. Rather, one of ordinary skill in the art having the benefit of the present disclosure will understand that some of the process blocks may be executed in a variety of orders not illustrated.

In a process block 605, the DC bias current is applied through drive electrode 115 and across gain region 165 to ground electrode 120. The DC bias current and associated DC bias voltage forward biases gain region 165 resulting in stimulated emission of an optical wave by gain region 165 (process block 610). In a process block 615, the optical wave resonates within lower and upper resonant cavities 105 and 110 resulting in lasing at the carrier wavelength (process block 615). In a process block 620, a DC reverse bias voltage is applied across absorber region 185 between signal electrode 125 and ground electrode 120. In a process block 625, a signal voltage containing the electrical signal to be modulated onto the optical carrier wave is superimposed on the DC reverse bias voltage. The signal voltage applied across absorber region 185 results in a corresponding modulation of the absorption coefficient of absorber region 185 due to the Quantum Confined Stark Effect (“QCSE”).

QCSE is a phenomenon which arises when an electric field is applied across the plane of heterostructure superlattices (e.g., the MQD and the MWQ described above). In a quantum well at zero electric field, the electron and hole quantized energy levels are defined by the well width (dimensions H and W in FIGS. 3 and 4), stress within the quantum structure, and the band gap energy of the materials used to form the quantum well and the barrier. The electrons and holes occupy quantized energy states at least in one direction. When an electric field is applied, the electrons and holes are forced apart and their quantized energy states are altered. This has the effect of shifting the absorption resonance, as well as, modulating the strength of absorption (i.e., absorption coefficient). From a quantum mechanical perspective, if a photon having sufficient energy passes in the vicinity of a quantum well, there is a statistical probability that direct optical absorption of the photon by an electron in the valence band of the quantum well will occur, thereby raising the electron from the valence band into the conduction band, otherwise known as the formation of an exciton (electron-hole pair). Modulation bandwidths achievable via the QCSE are in principle much higher than the modulation bandwidths achievable by directly modulating the excited state population of gain region 165. For example, absorber region 185 may be modulated at 100 GHz and higher.

In one embodiment, EAVM 100 is a tunable optical source capable of amplitude modulation at different optical wavelengths. As mentioned above, applying a voltage modulation across absorber region 185 not only modulates the optical absorption coefficient of absorber region 185 (amplitude modulation), but also modulates the index of refraction of absorber region 185 (or the absorption resonance wavelength). The absorption coefficient and the index of refraction are related by what is called the Kramers-Kronig relation. Accordingly, the nominal or center wavelength of absorption of absorber region 185 may be tuned by varying the DC reverse bias voltage applied across signal electrode 125 and ground electrode 120. Therefore, bias applied to absorber region 185 is used to control absorption losses in the mode and the value of coupling between the gain region 165 and absorber region 185. Additionally, at the time of fabrication, the geometry (e.g., Bragg wavelength and cavity length) of lower and upper resonant cavities 105 and 110 may be selected to select different wavelengths of operation.

EAVM 100 may be used as a general electro-optic building block, which may be tailored for a variety of electro-optic applications, such as an optical detector. An optical detector can be made to be tunable by placing the optical detector within a Fabry-Perot cavity. The Fabry-Perot cavity acts as a resonator to enhance the optical field intensity within the cavity at particular wavelength, or quarter, half, or full multiples thereof, via constructive interference. By placing the optical detector at peak E-field intensity locations within the Fabry-Perot cavity, as illustrated in FIG. 5, the quantum efficiency of the optical detector is enhanced, since electrical carrier generation is proportional to photon density. When EAVM 100 is operated in the optical detector regime, upper resonant cavity 110 acts as a Fabry-Perot cavity to enhance and concentrate the photon density of received optical signal 197 between upper reflector 190 and middle reflector 170. In one embodiment, absorber region 185 is positioned within upper resonant cavity 110 to coincide with one of E-field intensity peaks 505 (FIG. 5).

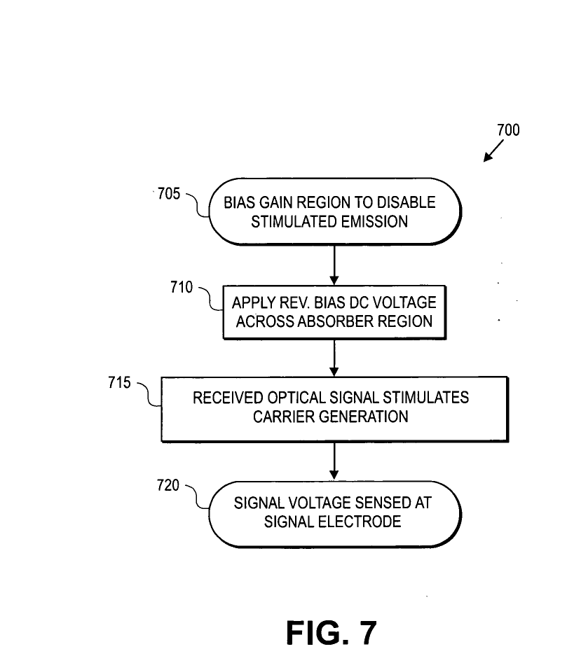

FIG. 7 is a flow chart illustrating a process 700 for operating EAVM 100 in an optical detector regime, according to an embodiment of the invention. In a process block 705, gain region 165 is disabled to prevent lasing by application of an appropriate DC bias voltage (for example not forward biased or left unbiased). In a process block 710, absorber region 185 is reverse biased by application of a DC reverse bias voltage across signal electrode 125 and ground electrode 120. In a process block 715, optical signal 197 is received through surface aperture 195 and resonates within upper resonant cavity 110. The resonance of received optical signal 197 results in electrical carrier generating within absorber region 185. The generated electrical carriers within absorber region 185 create a signal voltage, which is sensed at signal electrode 125 and extracted as a received electrical signal (process block 720).

The active, passive, and DBR layers of EAVM 100 may fabricated using known molecular beam epitaxy (“MBE”) and metal-organic chemical vapor deposition (“MOCVD”) techniques, as well as others. Furthermore, EAVM 100 may be fabricated in a single epitaxial run to deposit both gain region 165 and absorber region 185 on a single semiconductor die, as a monolithically integrated device. Upper reflector 190 may be fabricated using a “quarter-wavelength thick” dielectric stack, which is deposited on top of signal electrode 125.

EAVM 100 may be used to optically interconnect a variety of different electronic circuits residing on the same semiconductor die, residing on different semiconductor dies (chip-to-chip), residing on different circuit boards (board-to-board and blade-to-blade), residing within different systems (system-to-system), or residing within different compute centers (rack-to-rack), as well as others.

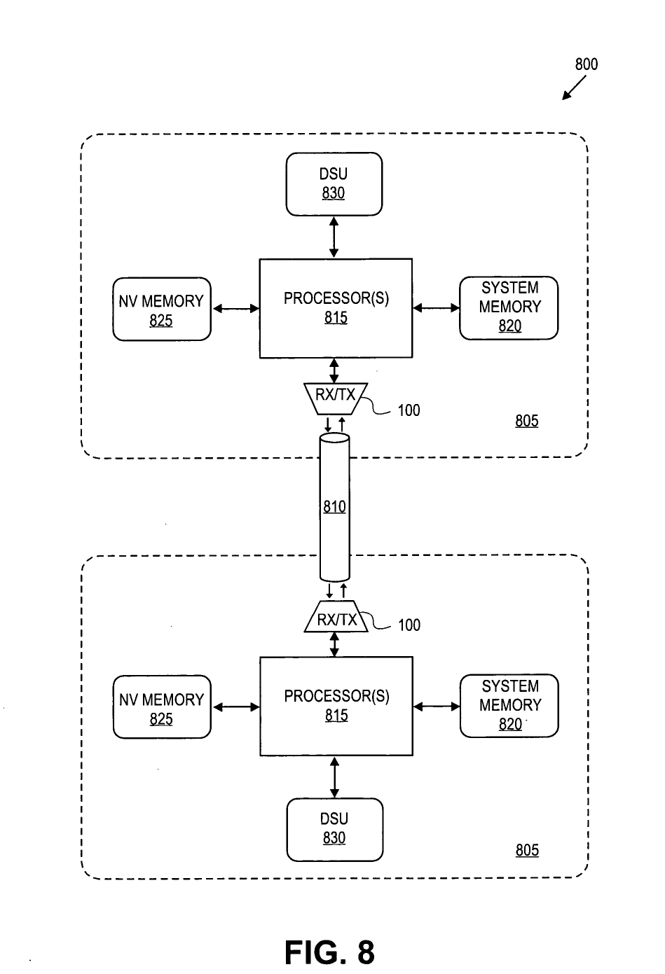

FIG. 8 is a functional block diagram illustrating a demonstrative system 800 implemented with EAVMs 100, in accordance with an embodiment of the invention. The illustrated embodiment of system 800 includes two electronic circuits 805 optically interconnected via a waveguide 810. The illustrated embodiment of electronic circuits 805 each include an EAVM 100, one or more processors 815, system memory 820, non-volatile (“NV”) memory 825, and a data storage unit (“DSU”) 830. It should be appreciated that system 800 is only intended as an example implementation of EAVM 100. Some of the illustrated components of system 800 need not be included while other non-illustrated components have been excluded so as not to obscure the invention.

The elements of electronic circuits 805 may be interconnected as follows. Processor(s) 815 are communicatively coupled to system memory 820, NV memory 825, DSU 830, and EAVM 100 to send and to receive instructions or data thereto/therefrom. In one embodiment, NV memory 825 is a flash memory device. In other embodiments, NV memory 825 includes any one of read only memory (“ROM”), programmable ROM, erasable programmable ROM, electrically erasable programmable ROM, or the like. In one embodiment, system memory 820 includes random access memory (“RAM”), such as dynamic RAM (“DRAM”), synchronous DRAM, (“SDRAM”), double data rate SDRAM (“DDR SDRAM”) static RAM (“SRAM”), and the like. DSU 830 represents any storage device for software data, applications, and/or operating systems, but will most typically be a nonvolatile storage device. DSU 830 may optionally include one or more of an integrated drive electronic (“IDE”) hard disk, an enhanced IDE (“EIDE”) hard disk, a redundant array of independent disks (“RAID”), a small computer system interface (“SCSI”) hard disk, and the like.

In one embodiment, EAVM 100 is electrically coupled to processor 815 via signal electrode 125 and optically coupled to waveguide 810, via a butt connection or the like with surface aperture 195, such that processors 815 of each electronic circuit 805 may communicate over waveguide 810 at high speed. EAVMs 100 may be used as optical transmitters only, optical receivers only, or optical transceivers. Embodiments of waveguide 810 may include free space, an optic fiber, a planar waveguide, an integrated waveguide (e.g., rib waveguide integrated within a semiconductor die including both electronic circuits 805), and the like.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A semiconductor die, comprising:
a lower reflector;
an upper reflector;
a middle reflector disposed between the lower and upper reflectors, the lower and middle reflectors defining a first resonant cavity within the semiconductor die, the upper and middle reflectors defining a second resonant cavity within the die optically coupled with the first resonant cavity;
an gain region disposed within the first resonant cavity to generate an optical carrier wave; and
an absorber region disposed within the second resonant cavity, the absorber region to modulate a signal on the optical carrier wave when subjected to a signal voltage.

2. The semiconductor die of claim 1, wherein the absorber region includes a first quantum confinement structure to modulate the optical carrier wave via a Quantum Confined Stark Effect.

3. The semiconductor die of claim 2, wherein the first quantum confinement structure comprises multiple layers of quantum wells.

4. The semiconductor die of claim 2, wherein the first quantum confinement structure comprise at least one substantially planar array of quantum dots.

5. The semiconductor die of claim 2, wherein the gain region comprises a second quantum confinement structure to generate the carrier wave.

6. The semiconductor die of claim 2, wherein the absorber region is positioned within the second resonant cavity to align with a peak electric field intensity of the carrier wave.

7. The semiconductor die of claim 2, wherein the lower, middle, and upper reflectors comprise lower, middle, and upper Bragg reflectors, respectively, and wherein the middle and upper Bragg reflectors are partially reflective to transmit a portion of the optical carrier wave through the middle and upper Bragg reflectors.

8. The semiconductor die of claim 7, wherein the lower, middle, and upper Bragg reflectors include alternating layers of GaAs and AlGaAs, and wherein the quantum confinement structure includes an InGaAs material surrounded by an AlGaAs material.

9. The semiconductor die of claim 7, wherein the upper and lower Bragg reflectors are doped to have a first conductivity type and the middle Bragg reflector is doped to have a second conductivity type of opposite polarity to the first conductivity type.

10. The semiconductor die of claim 9, further comprising:
a ground electrode to supply a ground potential;
a drive electrode to forward bias the gain region and to supply a direct current (“DC”) drive current to stimulate the gain region; and
a signal electrode to reverse bias the absorber region and to supply the signal voltage.

11. The semiconductor die of claim 10, further comprising:
first barrier layers disposed on either side of the gain region;
an oxide layer having a confinement aperture formed through the oxide layer, the oxide layer disposed between the lower Bragg grating and one of the first barrier layers;
second barrier layers disposed on either side of the absorber region; and
a surface aperture disposed proximate to the upper Bragg grating to emit the portion of the optical carrier wave from the semiconductor die.

12. The semiconductor die of claim 2, wherein the upper and middle reflectors define a Fabrey-Perot resonant cavity and wherein the absorber region is capable of generating an electrical signal in response to an impinging optical signal.

13. A method, comprising:
forward biasing a first resonant cavity including an gain region disposed within a first resonant cavity to generate a carrier wave;
reverse biasing a second resonant cavity including an absorber region disposed within the second resonant cavity, the second resonant cavity optically coupled with the first resonant cavity to receive at least a first portion of the carrier wave; and
modulating a voltage indicative of a signal across the absorber region to modulate the signal on the first portion of the carrier wave.

14. The method of claim 13, wherein the first and second resonant cavities are substantially vertically aligned within a single semiconductor die, and further comprising:
emitting a second portion of the optical carrier wave, having the signal modulated thereon, from a surface aperture of the semiconductor die.

15. The method of claim 14, further comprising optically confining a lateral dimension of the optical carrier wave with a confinement aperture defined within an oxide layer disposed within the first resonant cavity

16. The method of claim 15, further comprising driving the gain region with a direct current (“DC”) drive current confined to flowing through the confinement aperture of the oxide layer to concentrate injection current of the gain region above the confinement aperture.

17. The method of claim 14, wherein modulating the voltage indicative of the signal across the absorber region to modulate the signal on the first portion of the optical carrier wave comprises modulating absorption properties of a quantum well structure within the absorber region with the voltage indicative of the signal.

18. A system, comprising:
a first processor coupled to synchronous dynamic random access memory (“SDRAM”);
a transmitter electrically coupled to the first processor, the transmitter including:
lower and upper reflectors disposed within a die;
a middle reflector disposed between the lower and upper reflectors, the lower and middle reflectors defining a first resonant cavity within the die, the upper and middle reflectors defining a second resonant cavity within the die and optically coupled with the first resonant cavity;
an gain region disposed within the first resonant cavity to generate a carrier wave; and
an absorber region disposed within the second resonant cavity, the absorber region to modulate a signal on the optical carrier wave when subjected to a signal voltage;
a second processor;
a receiver electrically coupled to the second processor; and
a waveguide optically coupling the transmitter to the receiver to provide communications between the first and second processors.

19. The system of claim 18, wherein the absorber region includes a quantum confinement structure to modulate the optical carrier wave via a Quantum Confined Stark Effect.

20. The system of claim 19, wherein the first and second processors are disposed on different circuit boards and the waveguide comprises an optic fiber.

21. The system of claim 19, wherein the first and second processors, the transmitter and the receiver are all disposed within a single semiconductor die.
